(19) United States
(12) Patent Application Publication
(10) Pub. No.: US 2017/0261170 A1
(43) Pub. Date: Sep. 14, 2017

(54) HEADLIGHT AND METHOD FOR OUTPUTTING LIGHT USING SAME

(71) Applicant: LG ELECTRONICS INC., Seoul (KR)

(72) Inventors: Georgy TANANAEV, Seoul (KR); Kyungdong CHOI, Seoul (KR)

(21) Appl. No.: 15/306,815

(22) PCT Filed: Jan. 12, 2015
(86) PCT No.: PCT/KR2015/000284

§ 371 Date: Oct. 26, 2016

(30) Foreign Application Priority Data
Sep. 1, 2014 (KR) 10-2014-0115258

(51) Int. Cl. F21S 8/10; B60Q 1/14; B60Q 1/04

(52) U.S. Cl. CPC F21S 48/1241; B60Q 1/04; F21S 48/1388; B60Q 1/1423

(57) ABSTRACT

A headlight is disclosed. The headlight comprises: a light-guiding unit, the inner surface of the front surface of the light-guiding unit being coated with a totally-reflecting material; at least one light-emitting device fixed to the inner surface of the side surface of the light-guiding unit; a power supply unit for supplying power to each light-emitting device; at least one prism arranged on the inner surface of the rear surface of the light-guiding unit so as to reflect light from each light-emitting device; and a control unit for controlling power of the power supply unit, wherein light emitted from the light-emitting device is reflected at the prism and at the inner surface of the front surface and is discharged to the outside of the light-guiding unit. Accordingly, the device usability and efficiency can be improved.

### TECHNICAL FIELD

The present invention relates to a headlight and method of projecting light therein, and more particularly, to a headlight having a prism mounted thereon and method of projecting light therein.

### BACKGROUND ART

A headlight mounted on a vehicle is an essential component to a vehicle. A design aspect as well as a functional aspect is currently considered.

In a related art headlight, a light source is disposed on a rear surface and light is discharged toward a front side, generally.

However, such a headlight necessarily occupies a considerable space. As such, a need for a headlight capable of enhancing space usability of a vehicle is on the increase.

### DISCLOSURE OF THE INVENTION

### Technical Task

One technical task of the present invention is to provide a thin headlight and method of projecting light therein.

Another technical task of the present invention is to provide a headlight and method of projecting light therein, by which light loss of a light source is reduced in a manner of applying a function of total reflection attributed to an inter-medium refractive index difference to the headlight.

Technical tasks obtainable from the present invention are non-limited by the above-mentioned technical task. And, other unmentioned technical tasks can be clearly understood from the following description by those having ordinary skill in the technical field to which the present invention pertains.

### Technical Solutions

In one technical aspect of the present invention, provided herein is a headlight, including a light-guiding unit and a main body unit closely attached to one lateral side of the light-guiding unit, the main body unit including at least one light-emitting device fixed to a surface closely attached to the one lateral side of the light-guiding unit to emit light towards an inside of the light-guiding unit and a controller configured to control light emission of each of the at least one light-emitting device, wherein the light-guiding unit includes a plurality of first prisms provided to a rear side of the light-guiding unit and wherein if the light emitted towards the inside of the light-guiding unit from each of the at least one light-emitting device totally reflects from a front side of the light-guiding unit in an internal direction, a plurality of the first prisms reflect the totally reflecting light to be discharged in a front direction of the light-guiding unit.

### Advantageous Effects

According to various embodiments of the present invention, a thin headlight is provided, thereby enhancing space usability of a device.

And, a light loss is reduced by applying a total reflection function using a refractive index difference between media, thereby enhancing device efficiency.

Effects obtainable from the present invention are non-limited by the above mentioned effect. And, other unmentioned effects can be clearly understood from the following description by those having ordinary skill in the technical field to which the present invention pertains.

### DESCRIPTION OF DRAWINGS

FIG. 1 is a diagram to illustrate a shape of a headlight according to one embodiment of the present invention.

FIG. 2 is a layout of a headlight according to one embodiment of the present invention.

FIG. 3 is a block diagram of a main body unit of a headlight 100 according to one embodiment of the present invention.

FIG. 4 is a sequence diagram to illustrate a method of projecting light in a headlight according to one embodiment of the present invention.

FIG. 5 is a diagram to illustrate one embodiment of a method of projecting light in a headlight according to the present invention.

### BEST MODE FOR INVENTION

Hereinafter, embodiments disclosed in the present specification will be described with reference to the attached drawings. Like reference numerals designate like elements throughout the specification irrespective of symbols in the drawings. In the description below, terms such as “module” and “unit” are used for clarity and the terms themselves do not have a distinctive meaning. Furthermore, when embodiments disclosed in the present specification are described, if it is determined that the specific description for a known related art may obscure the gist of embodiments disclosed in the present specification, the detailed description thereof will be omitted. Furthermore, the attached drawings are merely for an easier understanding of the disclosed embodiments. The technical concept disclosed in the present specification is not limited by the attached drawings and it should be construed to include all changes, equivalents and substitutes included in the concept and technical scope of the present invention.

Terms such as ordinal numbers such as “first” and “second” may be used to describe various elements, but the elements are not limited by the terms. The terms are used only for the purpose of distinguishing one element from another.

When it is mentioned that one element is “linked” or “connected” to another element, the one element may be directly linked or connected to the another element, but it should also be understood that there may be a different element bewteen the one element and the another element. On the other hand, when it is mentioned that one element is “directed linked” or “directly connected” to another element, it should be understood that there is no different element inbewteen.

Unless clearly indicated otherwise by the context, a singular expression includes a plural expression.

In the present application, terms such as “comprise” and “have” are used to indicate that a number, a step, an operation, a component, a part or a combination thereof exist, but it should not be understood that the existence or possibility of addition of one or more other characteristics, a number, a step, an operation, a component, a part or a combination thereof is excluded in advance.

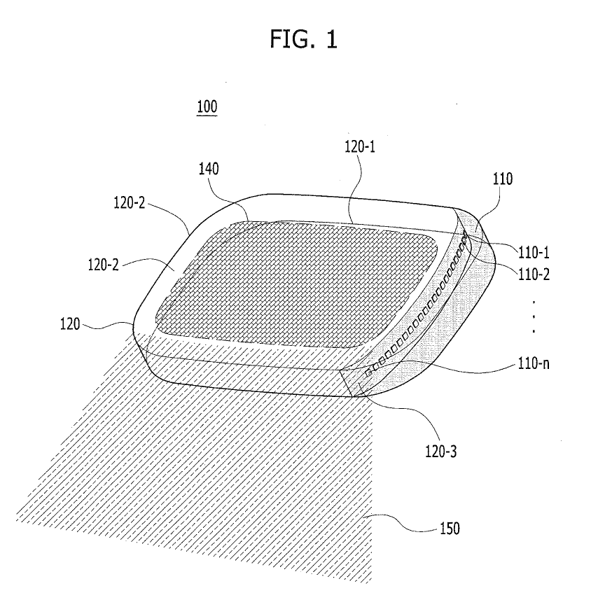

FIG. 1 is a diagram to illustrate a shape of a headlight according to one embodiment of the present invention.

Referring to FIG. 1, a headlight 100 includes a main body unit 110 and a light-guiding unit 120.

The main body unit 110 includes a pluralty of light-emitting devices 100-1 to 100-n fixed to a surface closely attached to one side surface of the light-guding unit 120 to emit light towards the inside of the light-guiding unit 120. And, the main body unit 110 may include a controller 300 configured to control the pluralty of the light-emitting devices 110-1 to 110-n.

The light-guiding unit 120 includes a front part 120-1 having light of the headlight 100 mainly discharged therefrom outside the headlight 100, a rear part 120-2 having a plurality of prisms 140 disposed on an opposite side of the front part 120-1, and a lateral part having a plurality of the light-emitting devices 110-1 to 110-n disposed thereon.

And, a shape of the light-guiding unit 120 may be a flat type or a curved type. In this case, the flat type means that the front part 120-1 is flat. The curved type means that the front part 120-1 is curved.

Moreover, the inside of the light-guiding unit 120 may be molded with a specific material. For example, the inside of the light-guiding unit 120 may be molded with a material such as polycarbonate. As such, inexpensive mass production is facilitated by a molding method such as plastic extrusion molding and the like.

Moreover, a pluralty of the light-emitting devices 110-1 to 110-n correspond to the light source of the headlight 100. A plurality of the light-emitting devices 110-1 to 110-n may be turned on/off by being supplied with power through a power supply unit 320 which will be described later. The light-emtting devices 110-1 to 110-n may be disposed in a manner of being arrayed on one lateral part 120-3 of the light-guiding unit 120. The light-emitting devices 110-1 to 110-n may include LED, OLED or the like in general, but when implemented, can employ anything usable as a light source unconditionally.

Furthermore, the light source is disposed on the lateral part 120-3 of the headlight 100, and thus the thickness of the headlight 100 may become thinner than that of a related art headlight. As such, a vehicle space can be saved and such a feature has an advantage in terms of a design.

In this case, the thickness of the headlight 100 may be configured in a range between 5 mm and 20 mm. Yet, the thickeners of the headlight 100 may be influenced by the size, number and disposition of a plurality of the light-emitting devices 110-1 to 110-n.

A plurality of the prisms 140 may be disposed on an inner surface of the rear part 120-2 of the headlight 100. A pluralty of the prisms 140 can eventually discharge light out of of the headlight 100 by reflecting the light discharged from one lateral part 120-3 of the light-guiding unit 120. Each of a pluralty of the prisms 140 may be formed to have a slope and reflection angle of its own.

And, surfaces of a pluralty of the prisms 140 may be coated with a totally-reflective material or a mirroring material. In this case, light applied to a pluralty of the prisms 140 may be reflected.

An inner surface of the front part 120-1 of the light-guiding unit 120 may be coated with a totally-reflective material or a mirroring material. And, the inside and outside of the light-guiding unit 120 may be assumed as a first medium and a second medium, respectively. When light emitted from a pluralty of the light-emitting devices 110-1 to 110-n disposed on the lateral part 120-3 reaches the second medium from the first medium, if an incident angle is greater than a critical angle, the light totally reflects. On the other hand, if the incident angle of the first medium is smaller than the critical angle, the light is dischargedout of the headlight 100 (150).

Hereinafter, an operation for the headlight 100 to discharge light out of the headlight 100 will be described.

When light is emitted from a plurality of the light-emiting devices 110-1 to 110-n of one lateral part 120-2 by a user's manipulation, the light totally reflects from the inner surface of the front part 120-1 and also reflects from a pluralty of the prisms 140. Such a total reflection and a reflection can be repeatedly performed. Finally, the light is discharged out of the headlight 100 (150).

Meanwhile, the headlight 100 is mounted on a front part of a vehicle and driven by a controller which will be described later. An operation of the headlight 100 is turned on/off by a user manipulation. The headlight 100 corresponds to an essential component of the vehicle.

Meanwhile, it is described in the present specification that the headlight 100 is mounted on a vehicle, by which the present invention is non-limited. In case of implementation, only if power is supplied, the present headlight 100 may be adopted for various devices and operate in a stand-alone manner

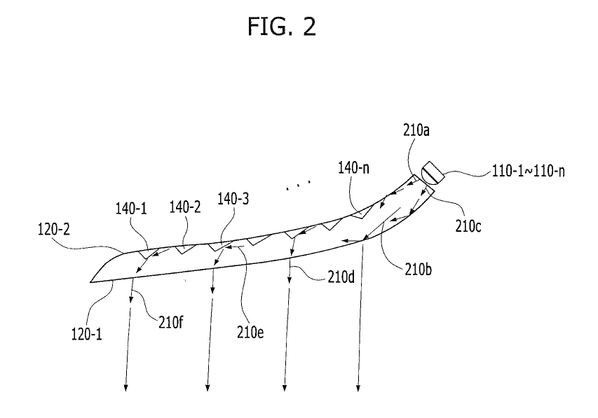

FIG. 2 is a layout of a headlight according to one embodiment of the present invention. FIG. 2 illustrates a case that a headlight 100 is observed from the top. Each of a front part 120-1, a rear part 120-2 and a lateral part 120-3 of a light-guiding unit 120 of the headlight 100 is configured as a curved surface.

Referring to FIG. 2, light is emitted from a pluralty of light-emitting devices 110-1 to 110-n. A plurality of the light-emitting devices 110-1 to 110-n are represented as one element according to the property of a layout. A plurality of prisms 140-1 to 140-n may be disposed on the rear part 120-2 of the light-guiding unit 120. The number of the prims is denoted by ‘n’ according to the property of the layout, but an additional prism may be disposed under a plurality of the prisms 140-1 to 140-n disposed on a topside.

Meanwhile, a plurality of the prisms 140-1 to 140-n disposed on the rear part 120-1 may be coated with a totally-reflective material or a mirroring material. Yet, a plurality of the prisms 140-1 to 140-n may not only reflect light but also transmit light.

In this case, the disposition, size and shape of the prisms 140-1 to 140-n may be variable depending on the configuration of the light-guiding unit 120 and the disposition of a pluralty of the light-emitting devices 110-1 to 110-n. Yet, each of the prisms 140-1 to 140-n is preferrably formed to have a different slope and a different reflection angle so that light can be most efficiently discharged out of the headlight 100 (particularly, so that light totally reflecting in an inner direction from the front part can be refracted to transmit the front part without totally reflecting again from the front surface part).

Although it is described in the present specification that prisms are disposed on the rear part 120-2 only, if it is effective for light to be discharged out of the healight 100, prisms may be disposed on the front part 120-1, a lateral side opposite to the light-emitting device disposed lateral side and the like.

Meanwhile, light is emitted in various directions 210a to 210f from a plurality of the light-emitting devices 110-1 to 110-n. For example, a first direction light 210a is a light applied from a plurality of the light-emitting devices 110-1 to 110-n and reflects from the rear part where a prism is not disposed. The first direction light 210 may be emitted by directly passing through the front part 120-1 without passing through a prism. Moreover, the first direction light 210a may totally reflects from the front part 120-1 so as to reflect from a prism. Such a difference may be generated depending on a refraction index bewteen media.

Second and third direction lights 210b and 210c totally reflects from a prescribed point of the front part 120-1. When an incident angle is greater than a critical angle acording to the property of total reflection, an applied light can reflect up to 100%. The second and third direction lights 210b and 210c may reflect on one of a plurality of the prisms 140-1 to 140-n so as to be discharged in a front direction of the headlight 100.

In this case, a plurality of the prisms 140-1 to 140-n may be configured to enable the second and third direction lights 210b and 210c to be applied in the front direction of the headlight 100 without totally reflecting from the light-guiding unit 120 or the prisms.

And, a fifth direction light 210e represents a light directly applied by a plurality of the light-emitting devices 110-1 to 110-n. The fifth direction light 210e reflects from a prism 140-3 and is directly discharged in the front direction of the headlight 100.

In this case, if the light of a plurality of the light-emitting devices 110-1 to 110-n can be most effectively discharged out of the headlight 100, the disposition, size and shape of the prisms 140-1 to 140-n may be configured in various ways. Each of the prisms 140-1 to 140-n may be configured to have a different slope and a reflection angle.

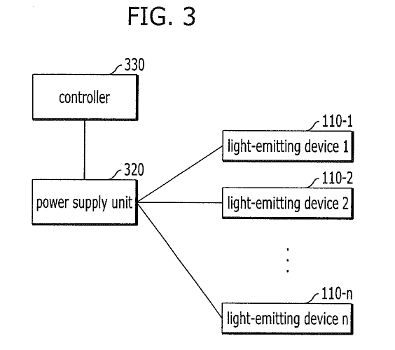

FIG. 3 is a block diagram of a main body unit of a headlight 100 according to one embodiment of the present invention.

Referring to FIG. 3, a main body unit 120 of the headlight 100 may include a plurality of light-emitting devices 110-1 to 110-n, a power supply unit 320 and a controller 330.

The power supply unit 320 may supply power to each of a plurality of the light-emitting devices 110-1 to 110-n. The power supply unit 320 is controlled by a controller 330.

When a preset event occurs, the controller 330 may adjust intensity of light of each of the light-emitting devices 110-1 to 110-n based on the occurring event.

The preset event may be triggered by a user manipulation. For example, the preset event may be triggered by a user manipulation of giving a command for turning on a high beam indciator light, a headlight, a flickering of a light-emitting device, a lighting mode or the like. When an event of the flickering of the light-emitting device occurs, the controller 330 may adjust a plurality of the light-emitting devices 110-1 to 110-n to be repeatedly turned on and off through power adjustment of the power supply unit 320.

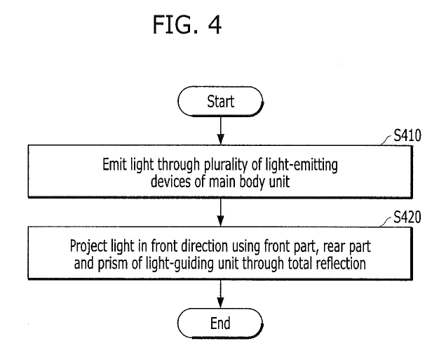

FIG. 4 is a sequence diagram to illustrate a method of projecting light in a headlight according to one embodiment of the present invention.

According to FIG. 4, the headlight 100 enables light to be emitted from a plurality of light-emitting devices of the main body unit 110 (S410).

Thereafter, the headlight 110 projects the light in a front direction using the front part, the rear part and the prism of the light-guiding unit 120 through total reflection (S420).

Details have already been described above, and thus they will be omitted.

Meanwhile, when a preset event occurs, the headlight 100 can adjust intensity of light of a light-emitting device based on the corresponding event. The corresponding event may be generally triggered by a user manipulation, by which the present invention non-limited. Only if the correspoding event is preset, no special restriction is put thereon.

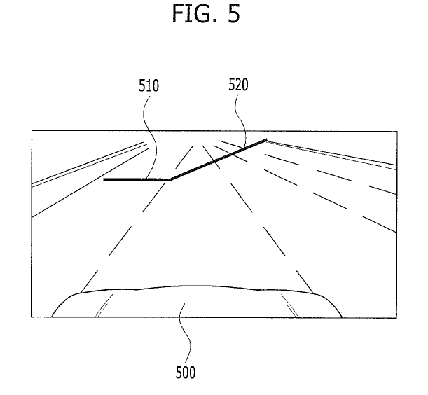

FIG. 5 is a diagram to illustrate one embodiment of a method of projecting light in a headlight according to the present invention.

Referring to FIG. 5, the headlight 100 of a vehicle 500 discharges light in a front direction of the vehicle 500.

In doing so, the controller 330 may discharge a large amount of the light to a second light-emitting area 520 rather than a first light-emitting area 510. Particularly, an output of a light-emitting device applying light to the first light-emitting area 510 may be set smaller than that of a light-emitting device applying light to the second light-emitting area 520.

And, by adjusting the disposition, slope and reflection angle of a plurality of the prisms 140 and the like, a light applied amount of the first light-emitting area 510 may be adjusted to be smaller than that of the second light-emitting area 520.

Accordingly, the controller 330 can set a amount of light applied to a specific location to be more or less, thereby enhancing user convenience.

The above-described present invention may be implemented as codes readable by a computer in a program-recorded medium. Media readable by a computer include all kinds of recording devices having data readble by a computer system stored therein. Some examples of media readable by a computer include a HDD (Hard Disk Drive), a SDD (Solid State Disk), a SDD (Silicon Disk Drive), a ROM, a RAM, a CD-ROM, a magnetic tape, a floppy disk drive and an optical data storage device and also include what is implemented in the form of a carrier wave (e.g., transmission through Internet). Furthermore, the computer may include a controller 180 of a user equipment. Therefore, the above detailed description should not be construed as restrictive but should be understood as illustrative. The scope of the present invention should be determined by a reasonable analysis of the attached claims, and all changes within the scope equivalent to that of the present invention are construed to be included in the scope of the present invention.

What is claimed is:

1. A headlight, comprising:
a light-guiding unit; and
a main body unit closely attached to one lateral side of the light-guiding unit,
the main body unit comprising:
at least one light-emitting device fixed to a surface closely attached to the one lateral side of the light-guiding unit to emit light towards an inside of the light-guiding unit; and
a controller configured to control light emission of each of the at least one light-emitting device,
wherein the light-guiding unit comprises a plurality of first prisms provided to a rear side of the light-guiding unit and
wherein if the light emitted towards the inside of the light-guiding unit from each of the at least one light-emitting device totally reflects from a front side of the light-guiding unit in an internal direction, a plurality of the first prisms reflect the totally reflecting light to be discharged in a front direction of the light-guiding unit.

2. The headlight of claim 1, wherein the first prism is configured to transmit the light totally reflecting from the front side or the light of the light-emitting device without totally reflecting again from the front side of the light-guiding unit.

3. The headlight of claim 1, wherein the light-guiding unit further comprises a plurality of second prisms provided to the rear side of the light-guiding unit to reflect the light emitted towards the inside to be directly discharged in the front direction of the light-guiding unit.

4. The headlight of claim 1, wherein at least one selected from the group consisting of the front side, the rear side and the latera side of the light-guiding unit is formed as a curved surface.

5. The headlight of claim 1, wherein if a preset event occurs, the controller adjusts an intensity of the light of each of the at least one light-guiding device based on the occurring event.
